(19) United States
(12) Patent Application Publication
(10) Pub. No.: US 2011/0253103 A1
(43) Pub. Date: Oct. 20, 2011

(54) Tug Boat Engine Emissions Control Suite

(76) Inventors: Mahesh Talwar, Somis, CA (US); Francois Bernard, New Hope, PA (US)

(21) Appl. No.: 12/840,254

(22) Filed: Jul. 20, 2010

Related U.S. Application Data
(63) Continuation-in-part of application No. 12/759,890, filed on Apr. 14, 2010.

(51) Int. Cl. F02D 7/00

(52) U.S. Cl. 123/445

(57) ABSTRACT

A tug boat diesel engine emissions control suite includes modified fuel injectors including a fuel injection timing retard feature, and diesel fuel heating. Tug boats are now required to comply with USEPA emission standards under 40 CFR Part 94 regulations. Retarding the fuel injection timing reduces peak temperatures during combustion which in turn reduces production of Nitrogen Oxides (NOx) but also increases emissions of particulate matter (PM), Carbon Monoxide (CO), and Hydrocarbons (HC) in the exhaust. Heating the diesel fuel provides a reduction in increased PM, CO, and HC to acceptable levels. Experiments showed that a novel modification to a plunger in the fuel injectors providing up to six degrees of fuel injection timing retarding, and fuel heated to 120 to 140 degrees Fahrenheit, resulted in meeting the 40 CFR Part 94 regulations.

The present application is a Continuation In Part of U.S. patent application Ser. No. 12/759,890 filed Apr. 14, 2010, which application is incorporated in its entirety herein by reference.

### BACKGROUND OF THE INVENTION

The present invention relates to the control of tug boat engines and in particular to reducing emission levels of tug boat engines to comply with USEPA emission standards under 40 CFR Part 94 regulations which became effective in January 2004.

USEPA emission standards under 40 CFR Part 94 became effective in January 2007 for category 2, engine displacement between five and fifteen liters cylinder. The standards include:

Nitrogen oxides (Nox)+Total Hydrocarbon: (THC)=7.8 grams/kw-hr

Carbon Monoxide (CO)=5 gms/kw-hr; and

Particulate matter (PM)=0.27 gms/kw-hr.

The above standards are also known as Tier 2 standards.

Tug boats commonly use an Electro Motive Division (EMD) 645 series engine. The 645 series engines are a family of eight, twelve, sixteen and twenty cylinder 45 degree Vee two stroke diesel engines used as locomotives, marine, and stationary engines. Each engine includes the same bore and stroke producing 645 cubic inches per cylinder, and include a roots blower or a turbocharger. The 645 series engines have been replaced by 710 series engines, but are still in use, for example, in the tug boats.

Two stroke diesel engines include exhaust valves in the head(s) and intake ports low in the cylinder walls which are covered by the pistons during most of an engine cycle and briefly uncovered to allow air to enter the cylinder. The exhaust valves are opened by a cam(s) when the piston nears Bottom Dead Center (BDC) at the end of the power stroke and close after the intake ports are uncovered by the piston, resulting in both the exhaust valves being open and the intake ports uncovered at the same time. The two stroke diesels require a supercharger to force air through the intake ports and into the engine because there is no vacuum to draw air into the cylinder. The piston again covers the intake ports shortly after beginning the compression stroke. Fuel is injected into the engine near Top Dead Center (TDC) and is ignited by heat in the cylinder at the beginning of the power stroke. Such diesel engines would be less efficient than gasoline engines, except for the fact that because the diesel fuel is not in the cylinder during the compression stroke, a higher compression is useable with a diesel engine than a gasoline engine, and the thermal efficiency of the engine increases with compression ratio.

Various methods have been exercised to reduce the emissions of tug boats using the EMD 645 series engines. Unfortunately, while known methods address some of the Tier 2 standards, the known methods have failed to address all of the standards.

### BRIEF SUMMARY OF THE INVENTION

Various aspects of the present invention address the above and other needs by providing a tug boat diesel engine emissions control suite including modified fuel injectors with a built in injection timing retard feature and diesel fuel heating. Tug boats are now required to comply with USEPA emission standards under 40 CFR Part 94 regulations. Retarding the fuel injection timing reduces peak temperatures during combustion which in turn reduces production of Nitrogen Oxides (NOx) but also increases emissions of particulate matter (PM), Carbon Monoxide (CO), and Hydrocarbons (HC) in the exhaust. Heating the diesel fuel provides a reduction in PM, CO, and HC to acceptable levels. Experiments showed that a novel modification to a plunger in the fuel injectors providing up to six degrees of fuel injection timing retarding, and fuel heated to 120 to 140 degrees Fahrenheit, resulted in meeting the 40 CFR Part 94 regulations.

In accordance with one aspect of the invention, there is provided an emissions control suite which includes a simple and effective modification to existing fuel injectors to retard fuel injection timing. Retarding the fuel injection timing reduces peak temperatures during combustion which in turn reduces production of Nitrogen oxides (NOx). The fuel injection timing is retarded by using a modified fuel injector plunger which retards the fuel injection timing as the quantity of fuel injected is increased, thereby reducing NOx. In a preferred embodiment, the fuel injection timing retarding varies between two and six degrees depending on the load on the engine.

In accordance with another aspect of the invention, there is provided an emissions control suite which heats the diesel fuel to reduce PM, CO, and HC to acceptable levels. Retarding the fuel injection timing reduces NOx but unfortunately increases emissions of Particulate Matter (PM), Carbon Monoxide (CO), and Hydrocarbons (HC) in the exhaust. Unrelated efforts by the present inventors to reduce the smoke in diesel exhaust by pre-heating the diesel fuel showed an unexpected reduction in PM, CO, and HC. Such heating of the diesel fuel is expected to increase combustion temperature and thus NOx, but unexpectedly, a substantial increase in fuel temperature, from 70 degrees Fahrenheit to as much as 140 degrees Fahrenheit did not overcome the reduction in NOx provided by the retarded fuel injection timing, but did reduce PM, CO, and HC emissions to satisfy 40 CFR Part 1042 and Part 94 regulations. Further experiments showed that an unexpected synergistic combination of fuel injection retarding and fuel heated to approximately 140 degrees Fahrenheit resulted in meeting the 40 CFR Part 1042 and Part 94 regulations. The temperature of the heated diesel fuel must be carefully controlled to not exceed approximately 140 degrees Fahrenheit which is approaching the flash point of the diesel fuel.

In accordance with yet another aspect of the invention, there is provided an emissions control suite which reduces emissions in diesel engines by increasing a compression ratio from a typical compression ratio between 14.5 to 1 and 16 to 1, to a compression ratio of 17.4 to 1 or higher. The higher compression ratio significantly reduces emissions of Particulate Matter (PM) but results in some increase in NOx emissions.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 is a functional block diagram of the emissions control suite according to the present invention.

FIG. 2 shows a diesel engine including the emissions control suite according to the present invention.

FIG. 3 is a diagram of a fuel heating element of an emissions control suite according to the present invention including an AMOT self powered 3-way Thermostatic Valve.

FIG. 4 is a diagram of a second fuel heating element of an emissions control suite according to the present invention including a fuel temperature sensor and a sensor controlled.

FIG. 5 is an example of a fuel injection timing chart according to the present invention.

FIG. 6 shows a cross-sectional view of a diesel fuel injector according to the present invention.

FIG. 7 shows a plunger of the diesel fuel injector according to the present invention.

FIG. 8 shows porting according to the present invention, near the base of the plunger, for control of fuel flow.

FIGS. 9A-9D show cooperation of the plunger porting with feed ports in the injector according to the present invention, with zero fuel flow into the engine.

FIGS. 10A-10D show cooperation of the plunger porting with feed ports in the injector according to the present invention, at idle.

FIGS. 11A-11D show cooperation of the plunger porting with feed ports in the injector according to the present invention, at half load and retarded timing.

FIGS. 12A-12D show cooperation of the plunger porting with feed ports in the injector according to the present invention, at full load and retarded timing.

Corresponding reference characters indicate corresponding components throughout the several views of the drawings.

### DETAILED DESCRIPTION OF THE INVENTION

The following description is of an embodiment presently contemplated for carrying out the invention. This description is not to be taken in a limiting sense, but is made merely for the purpose of describing one or more preferred embodiments of the invention, and other embodiments derived by those skilled in the art are intended to come within the scope of the present invention. The scope of the invention should be determined with reference to the claims.

Reduction of engine emissions have proven to be very difficult due to the complex nature of combustion in engines. Methods have generally consisted of trial and error and lack accurate models capable of predicting results. Further, emissions reduction is generally a non-linear multi-dimensional problem including the interaction of fuel control, air intake control, engine bore and stroke, combustion chamber design, operating temperatures, and other design and operation parameters. The overall environment of engine emissions control thus presents a complex problem with few obvious solutions when a single parameter is varied, and virtually no obvious solution when multiple interacting parameters are varied.

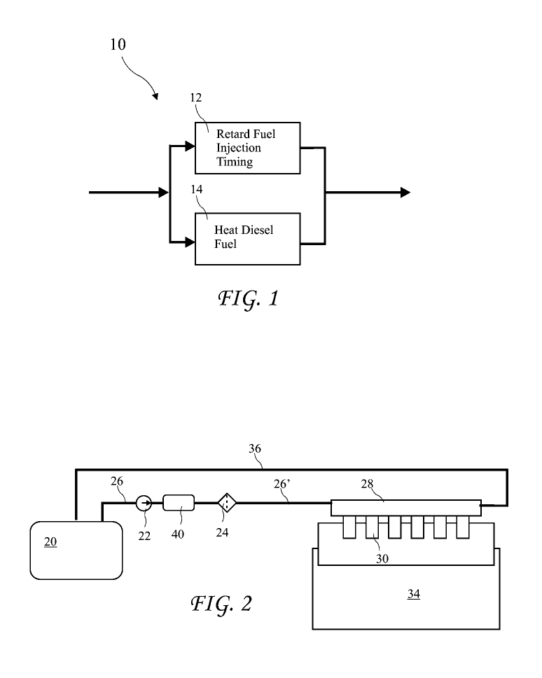

A functional block diagram of an emissions control suite 10 according to the present invention is shown in FIG. 1. The emissions control suite 10 may be retrofitted to an existing in-use Electro Motive Division (EMD) 645 series engines of a tug boat to meet recently enacted USEPA emission standards under 40 CFR Part 94 regulations. The emissions control suite 10 includes two essential elements, retarded fuel injection timing 12 and diesel fuel heating 14. The combination of retarding the fuel injection and heating the diesel fuel unexpectedly allows the diesel engine to meet the 40 CFR Part 94 regulations. An additional preferred element is a high compression power pack assembly including higher compression pistons and low oil consumption rings.

The fuel injector timing is retarded to delay the injection of diesel fuel to reduce peak combustion temperature. NOx is created when nitric oxide (NO) reacts with oxygen (O₂) to create nitrogen dioxide (NO₂). The lower peak combustion temperature reduces the chemical reaction reducing the production of NOx. Unfortunately, retarding the fuel injection timing also increased the emissions of particulate matter (PM), Carbon Monoxide (CO), and Hydrocarbons (HC).

There were no obvious methods for reducing the increased PM, CO, and HC in the diesel engine exhaust which resulted from retarding the fuel injection timing. However, an independent effort was underway to reduce diesel engine smoke. One approach to smoke reduction which was tried was to heat the diesel fuel to provide more complete combustion. The engine exhaust was being monitored as part of the test, and an unexpected reduction in PM, CO, and HC was observed. Once this reduction was identified, additional experiments were performed with varying fuel injection retarding and fuel heating. Test results eventually showed that retarded fuel injection timing coupled with heating the fuel to between 120 and 140 degrees Fahrenheit, and preferably near the 140 degrees Fahrenheit flash point of the diesel fuel, provided consistently good results meeting the 40 CFR Part 94 regulations.

A diesel engine 34 including the emissions control suite 10 according to the present invention is shown in FIG. 2. Unheated diesel fuel 26 is drawn from a fuel tank 20 by a low pressure pump 22. The unheated fuel 26 is provided to a fuel heater 40. The fuel heater 40 heats the fuel to provide heated fuel 26′. The heated fuel 26′ passes through a filter(s) 24 and into a fuel manifold 28 at between approximately 40 and 60 PSI. The fuel system is a flow through system with a return flow 36. Fuel injectors 30 are fed from the fuel manifold 28 and are actuated by a camshaft and injector rocker arms which creates the high pressure required for the diesel fuel injection. Typically, a mechanical rack actuated by a governor controls the high pressure injection of fuel into the combustion chambers, however, one will appreciate that other means may be used to deliver fuel into the combustion chambers.

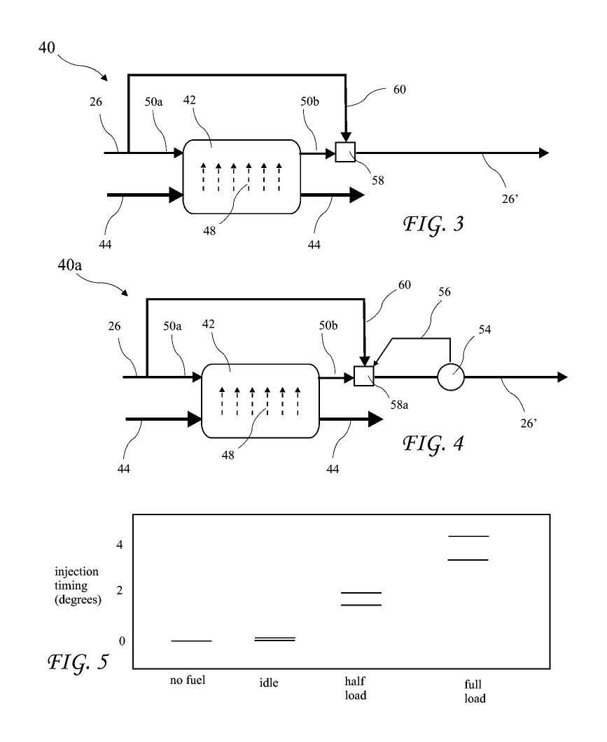

A diagram of a preferred heat diesel fuel element 14 of the emissions control suite 10 is shown in FIG. 3. The heat diesel fuel element 14 includes a heat exchanger 42 transferring heat 48 from a heated engine coolant flow 44 to a pre heat exchanger fuel flow 50a. Such heat transfer 48 provides a reliable and inexpensive source of heat. The flow of diesel fuel 26 is split between the pre heat exchanger fuel flow 50a into the heat exchanger 42 and a bypass flow 60 around the heat exchanger 42. The transferred heat 48 raises the temperature of the pre heat exchanger fuel flow 50a to provide a heated fuel flow 50b at an elevated temperature. The heated fuel flow 50b is combined with the bypass flow 60 by a valve 58 to provide a heated fuel flow 26′ to the diesel engine injectors 30. A flow control valve 58 regulates the combining the heated fuel flow 50b with the bypass flow 60 to control the temperature of the heated fuel flow 26′. The temperature of the heated fuel flow 26′ is preferably maintained between 120 and approximately 140 degrees Fahrenheit and is more preferably approximately 140 degrees Fahrenheit. Alternatively, the temperature of the heated fuel flow 26′ is maintained just below the flash point of the diesel fuel.

The flow control valve 58 is preferably a powered 3-way thermostatic valve which includes internal temperature regulating features to control the combining the heated fuel flow 50b with the bypass flow 60 to control the temperature of the heated fuel flow 26′. An example of a suitable flow control valve 58 is a AMOT self powered 3-way Thermostatic Valve with a target temperature designed into the valve.

A diagram of a second fuel heating element 40a of the emissions control suite according to the present invention is shown in FIG. 4. The fuel heating element 40a includes a fuel temperature sensor 54 and a sensor controlled 3-way valve 58a. The temperature of the heated fuel flow 26′ is measured by sensors 54 and a control signal 56 is used to control the flow control valve 58a regulating the combining the heated fuel flow 50b with the bypass flow 60 to control the temperature of the heated fuel flow 26′. Alternatively, the valve 58a may be a 2-way valve controlling only the bypass flow 60 or the heated fuel flow 50b to control the heated fuel flow 26′.

An example of suitable fuel injection timing is shown in a fuel injection timing chart according to the present invention in FIG. 5. The injection timing is referenced to zero fuel flow, and the amount of fuel injected is shown by the vertical spacing between lines for idle, half load, and full load. The injection retard is zero at idle, two degrees at half load, and four degrees at full load. The timing chart is a single example, and any fuel injection timing with increased retard with increase fuel flow is intended to come within the scope of the present invention. While FIG. 5 shows a maximum fuel injection timing retard of four degrees, the maximum fuel injection timing retard is preferably between approximately four degrees and approximately six degrees.

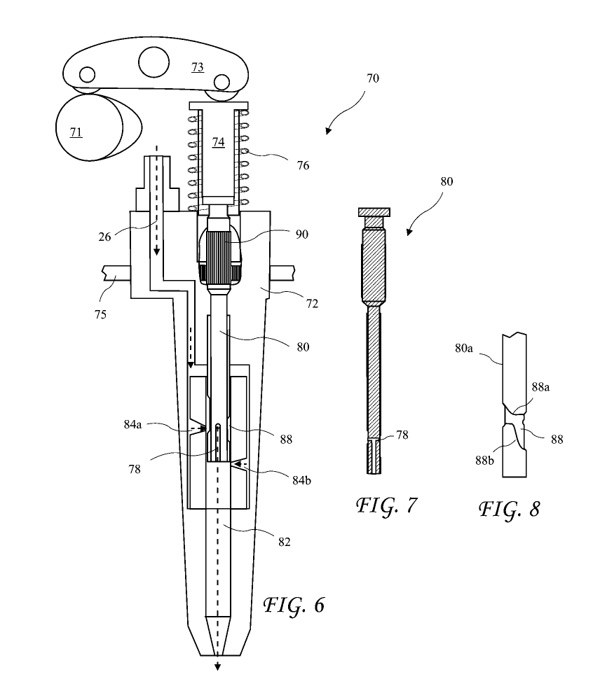

A cross-sectional view of a preferred diesel fuel injector 70 including self-adjusting fuel injection timing is shown in FIG. 6. The diesel fuel injector 70 includes a plunger 80 shown in FIG. 7. The plunger 80 has plunger porting 88 according to the present invention near the base of the plunger 80, as shown in FIG. 8. The plunger porting 88 designed to retard fuel injection timing with increased load. The plunger porting 88 comprises a recessed area on a cylindrical outer face of the plunger 80. A cam 71 and roller rocker arm 73 depress a cam follower 74 which overcomes a spring 76 and pushes the plunger 80 down. The fuel 26′ enters the injector body 72 and travels down to feed ports 84a and 84b. The fuel then flows through the feed ports 84a and 84b and cooperating plunger porting 88 and into an interior plunger passage 78. The fuel continues from the interior plunger passage 78 down through the injector body 72 past a check valve, valve spring, cage, and seat and out of the injector past a needle valve and orifice and into the diesel engine combustion chamber as a high pressure flow 82.

The plunger 80 acts as a high pressure fuel pump to overcome the pressure in the combustion chamber. The amount and timing of the fuel injected into the engine is determined by the overlap of the feed ports 84a and 84b with the plunger porting 88. The plunger porting 88 is shaped so that the plunger may be rotated to vary both the timing and amount of fuel injected. Specifically, the plunger 80 only pumps fuel into the engine when neither feed ports 84a and 84b overlaps the plunger porting 88. While feed ports 84a or 84b overlaps the plunger porting 88, as the plunger 80 is depressed downward, the fuel under the plunger 80 merely escapes back through the plunger 80 into the fuel manifold 28 (see FIG. 2). While neither feed ports 84a nor 84b overlap the plunger porting 88, downward motion of the plunger 80 provides an effective stroke and pumps fuel into the engine under very high pressure. More specifically, the feed port 84a cooperates with a ceiling 88a of the plunger port 88, and the feed port 84b cooperates with a floor 88b of the plunger port 88.

Rotation of the plunger 80 is controlled by a rack 75 cooperating with teeth 90 on the plunger 80. The teeth 90 extend vertically to allow continued engagement of the rack 75 with the teeth 90 when the plunger 80 is depressed by the cam 71 and rocker arm 73. The rack 75 connects all of the injectors 70 and controls the engine load jointly across all the injectors 70.

The cooperation of the plunger porting 88 with feed ports 84a and 84b with zero fuel flow into the engine is shown in FIGS. 9A-9D. The cylindrical plunger 80 is unwrapped to provide a planar view. FIG. 9A depicts the plunger 80 at the top of the stroke with the feed port 84a overlapping the plunger port 88. As the plunger 80 is depressed, the plunger port 88 moves below the feed port 84a, but immediately overlaps the feed port 84b. Because at least one of the feed ports 84a or 84b always overlap the plunger port 88, zero fuel is injected into the engine.

The cooperation of the plunger porting 88 with feed ports 84a and 84b with idle fuel flow into the engine is shown in FIGS. 10A-10D. FIG. 10A depicts the plunger 80 at the top of the stroke with the feed port 84a overlapping the plunger port 88. As the plunger 80 is depressed, the plunger port 88 moves below the feed port 84a, and briefly, neither of the feed ports 84a nor 84b overlap the plunger port 88, before the plunger port 88 travels sufficiently down to overlap the feed port 84b. Because one of the feed ports 84a or 84b overlaps the plunger port 88 during nearly all of the plunger stroke, only a small amount of fuel is injected into the engine.

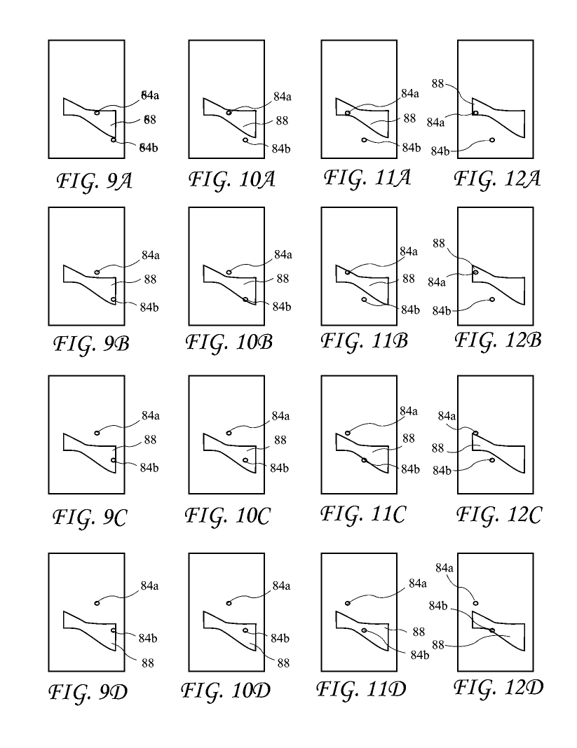

The cooperation of the plunger porting 88 with feed ports 84a and 84b with a half load fuel flow into the engine is shown in FIGS. 11A-11D. FIG. 11A depicts the plunger 80 at the top of the stroke with the feed port 84a overlapping the plunger port 88. The ceiling 88a of the plunger port slopes upward to the left, and as a result, the feed port 84a continues to overlap the plunger port 88 during the initial downward motion of the plunger 80 resulting in retarding the beginning of the injection of fuel into the engine. The floor 88b of the plunger port 88 slopes upward at a shallower angle than the ceiling 88a, and as a result, delays the overlap of the feed port 84b with the plunger port 88 longer than the retarding of the beginning of the injection, and results in an increase in the amount of fuel injected into the motor, compared to idle.

The cooperation of the plunger porting 88 with feed ports 84a and 84b with a full load fuel flow into the engine is shown in FIGS. 12A-12D. FIG. 12A depicts the plunger 80 at the top of the stroke with the feed port 84a overlapping the plunger port 88. The ceiling 88a of the plunger port continues to slope upward to the left, and as a result, the feed port 84a continues to overlap the plunger port 88 during the initial downward motion of the plunger 80 longer than at half load, resulting in even greater retarding the beginning of the injection of fuel into the engine compared to half load operation. The floor 88b of the plunger port 88 continues to slope upward at a shallower angle than the ceiling 88a, and as a result, delays the overlap of the feed port 84b with the plunger port 88 longer than the retarding of the beginning of the injection, and results in an increase in the amount of fuel injected into the motor, compared to idle.

One example of a plunger port shape is shown in FIGS. 9A-12D, and those skilled in the art will recognize that other shapes may be created, for example, based on the relative positions of the feed ports, to obtain the intended coupling of fuel load and timing, and any injector having a plunger port obtaining such retarding of fuel injection timing is intended to come within the scope of the present injection.

The amount of fuel injection timing retard and fuel heating disclosed above is based on results obtained for a limited variety of diesel engines. Other diesel engines include different types and methods of forced induction which often affect the temperature of air entering the engine and other engine parameters. As a result, variations to the amount of fuel injection timing retard and fuel heating disclosed here for the 645 series engines, to obtain similar reductions in emissions in other diesel engines, are intended to come within the scope of the present invention.

While the emissions control suite 10 provides a valuable reduction in emissions without additional modifications, tests have shown that some additional engine modification combined with the emissions control suite 10 are generally necessary to achieve Tier II emissions compliance. Increasing a compression ratio from a typical compression ratio between 14.5 to 1 and 16 to 1, to a compression ratio of 17.4 to 1 or higher, for example, by using high compression pistons, has been shown to significantly reduces emissions of PM. The higher compression ratio results in some increase in NOx emissions, but the fuel injection timing retard has shown to be sufficient to keep the NOx emissions within requirements. The use of low oil consumption cast iron or stainless steel ring sets on 17.4 to 1 compression pistons has further shown reduce oil consumption. An example of low oil consumption rings are pre-stress hardened rings. Additionally, plateau honing the liners (thereby increasing the bearing area of the liner while maintaining oil retention) and plating the pistons with a tin coating have shown potential advantages.

While the present invention is of particular value to tug boasts which are the target of USEPA emission standards under 40 CFR Part 94, the present invention has general application to any similar diesel engine, and any diesel engine modified according to the present invention to reduce emissions is intended to come within the scope of the present invention, and in particular, any marine vessel diesel engine modified according to the present invention to reduce emissions is intended to come within the scope of the present invention.

While the invention herein disclosed has been described by means of specific embodiments and applications thereof, numerous modifications and variations could be made thereto by those skilled in the art without departing from the scope of the invention set forth in the claims.

I claim:

1. An emissions controlled marine vessel diesel engine comprising:
a marine vessel;
a diesel engine installed in the marine vessel, the diesel engine providing power for motion of the marine vessel;
diesel fuel injectors including self-adjusting fuel injection timing, the diesel fuel injectors increasing the amount of the timing retard as the amount of fuel injected is increased;
diesel fuel heated before injection into the diesel engine; and
a high compression power assembly with a low-oil consumption ring set.

2. The emissions controlled marine vessel diesel engine of claim 1, wherein the fuel injectors include injector plungers forcing the injection of the fuel into the engine and an effective stroke of the plunger is increased and delayed as the load on the engine is increased.

3. The emissions controlled marine vessel diesel engine of claim 2, wherein the injector plungers are rotated to adjust the effective stroke of the plunger.

4. The emissions controlled marine vessel diesel engine of claim 2, wherein the injection plunger includes a plunger port which overlaps at least one feed port, and the effective stroke of the plunger results from a portion of the plunger stroke when the plunger port does not overlap the feed port.

5. The emissions controlled marine vessel diesel engine of claim 4, wherein feed port comprises two feed ports and a first feed port cooperates with a ceiling of the plunger port to determine the initiation of the effective stroke and the second feed port cooperates with a floor of the plunger port to determine an end of the effective stroke.

6. The emissions controlled marine vessel diesel engine of claim 4, wherein:
the injector plungers are rotated to adjust the effective stroke of the plunger;
the feed ports reside on opposite sides of the plunger; and
the ceiling of the plunger port slope upward to retard the initiation of the effective stroke; and
the floor of the plunger slopes upward at a shallower slope than the ceiling to provide a longer effective stroke for half and full load operation.

6. The emissions controlled marine vessel diesel engine of claim 1, wherein the diesel fuel is heated to between 120 and 140 degrees Fahrenheit before injection into the diesel engine.

7. The emissions controlled marine vessel diesel engine of claim 6, wherein the diesel fuel is heated to approximately 140 degrees Fahrenheit before injection into the diesel engine.

8. The emissions controlled marine vessel diesel engine of claim 1, wherein the diesel fuel is heated to just below the flash point of the diesel fuel before injection into the diesel engine.

9. The emissions controlled marine vessel diesel engine of claim 1, wherein the diesel fuel heater includes a diesel engine coolant to diesel fuel heat exchanger.

10. The emissions controlled marine vessel diesel engine of claim 1, wherein the diesel engine is a Electro Motive Division (EMD) 645 series engine.

11. The emissions controlled marine vessel diesel engine of claim 9, wherein the fuel injection timing is retarded between four degrees and six degrees at full load compared to idle.

12. The emissions controlled marine vessel diesel engine of claim 1, wherein the diesel engine has a compression ration of approximately 17.4.

13. The emissions controlled marine vessel diesel engine of claim 12, wherein the diesel engine includes plateau honing the liners and plating the pistons with a tin coating.

14. The emissions controlled marine vessel diesel engine of claim 1, wherein the diesel engine the fuel injection timing is adjusted from approximately two degrees of fuel injection timing retard at idle to between approximately four degrees and approximately six degrees of fuel injection timing retard at maximum load.

15. An emissions controlled tug boat diesel engine comprising:
a tug boat;
a Electro Motive Division (EMD) 645 series engine installed in the tug boat, the EMD 645 series engine providing power for motion of the tug boat;
a fuel tank containing diesel fuel for combustion in the EMD 645 series engine;
a fuel injection system including fuel injectors providing the diesel fuel to corresponding cylinders of the EMD 645 series engine;
a cam operating the fuel injectors to control the timing and amount of the diesel fuel injected into the cylinders;
a plunger residing inside each of the fuel injectors and actuated by the cam to pump fuel into the engine, the plunger rotatable to adjust an effective stroke determining the fuel injection timing and the amount of retard of the fuel injection from standard fuel injection timing to reduce NOx emissions, the fuel injection timing being adjust from approximately two degrees of fuel injection timing retard at idle to between approximately four degrees and approximately six degrees of fuel injection timing retard at maximum load;
a fuel system delivering the diesel fuel from the fuel tank to a fuel injection manifold in fluid communication with the fuel injectors; and
a heat exchanger receiving a flow of heated engine coolant and transferring heat from the heated engine coolant to a flow of the diesel fuel from the fuel tank to the injector manifold.

16. A method to reduce emissions of a diesel engine, wherein the diesel engine includes individual fuel injectors providing fuel from a fuel supply to corresponding cylinders, the method comprising:
the fuel injectors, during engine operation, jointly adjusting the load on the engine and the fuel injection timing, an increase in load coupled to greater retard of the fuel injection timing to reduce emissions of NOx from the engine; and
heating fuel supplied to the fuel injectors to above 120 degrees Fahrenheit to reduce Particulate Matter (PM), Carbon Monoxide (CO), and Hydrocarbons (HC) from the engine.
